(19) United States
(12) Patent Application Publication
(10) Pub. No.: US 2011/0159260 A1
(43) Pub. Date: Jun. 30, 2011

(54) MULTIPLE LAYER SYSTEM COMPRISING A METALLIC LAYER AND A CERAMIC LAYER

(76) Inventors: Alessandro Casu, Duisburg (DE); Oliver Lüsebrink, Witten (DE)

(21) Appl. No.: 12/979,483

(22) Filed: Dec. 28, 2010

(30) Foreign Application Priority Data
Dec. 29, 2009 (EP) 09016099.5

(51) Int. Cl. B32B 7/02; B32B 15/04

(52) U.S. Cl. 428/215; 428/457; 428/469; 428/212

(57) ABSTRACT

A multilayer coating system is provided. The multilayer coating system includes a substrate, a first metallic layer on the substrate, a first ceramic layer on the first metallic layer, a second metallic layer on the first ceramic layer, and an outermost ceramic layer on the second metallic layer. The multilayer coating system achieves a relatively high overall layer thickness since the critical layer thicknesses of the individual layers do not exceed the multilayer coating.

### CROSS REFERENCE TO RELATED APPLICATIONS

This application claims priority of European Patent Office application No. 09016099.5 EP filed Dec. 29, 2009, which is incorporated by reference herein in its entirety.

### FIELD OF INVENTION

The invention relates to a multiple layer system comprising metallic and ceramic layers.

### BACKGROUND OF INVENTION

Components which are subject to high thermal loading, e.g. blades or vanes in a gas turbine, are provided with a thermal barrier coating system. The thermal barrier coating system in question consists of a metallic bond coat (BC) and the actual ceramic thermal barrier coating (TBC). In the field of stationary gas turbines, the entire thermal barrier coating system (BC & TBC) is applied by means of thermal spraying (plasma spraying).

In the current prior art, the thickness of a coating system consisting of bond coat and thermal barrier coating is limited since, if the bond coat has a thickness of above 240 μm and additionally the TBC has a thickness of 500 μm-1500 μm, cracks appear even during coating and at least parts of the coating system flake off. In the production of very thick TBCs (>700 μm), in addition to the formation of cracks it is also observed that the upper part of the TBC becomes very dense. This low porosity results in a greatly reduced expansion tolerance. During operation, cracks which result in premature failure of the thermal barrier coating system are formed to a greater extent in this relatively dense region.

On account of this problem, the thickness of a TBC cannot be increased indefinitely so as to further increase the thermal insulation. In gas turbines, this problem opposes an increase in the gas inlet temperature and an associated increase in overall efficiency.

### SUMMARY OF INVENTION

It is therefore an object of the invention to solve the problem mentioned above.

The problem is solved by a multilayer coating system as claimed in the claims.

The dependent claims list further advantageous measures which can be combined with one another, as desired, in order to obtain further advantages.

### BRIEF DESCRIPTION OF THE DRAWINGS

FIG. 1 shows an exemplary embodiment,

FIG. 2 shows a gas turbine,

FIG. 3 shows a turbine blade or vane,

FIG. 4 shows a combustion chamber, and

FIG. 5 shows a list of superalloys.

The figures and the description represent only exemplary embodiments of the invention.

### DETAILED DESCRIPTION OF INVENTION

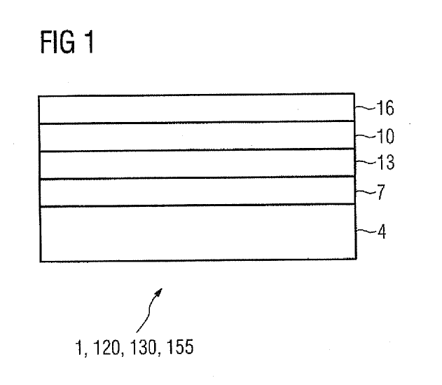

FIG. 1 shows a component 1, 120, 130, 155.

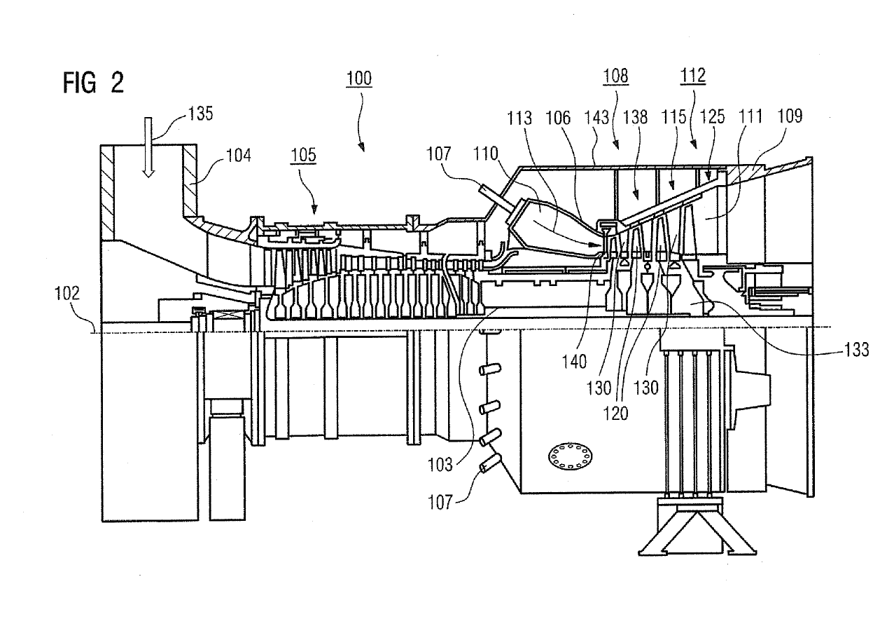

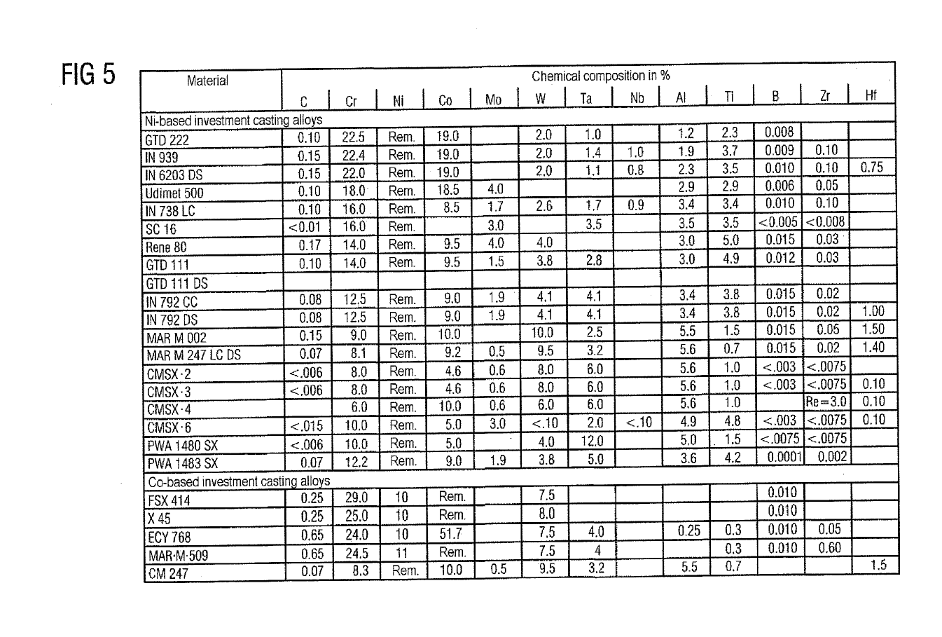

The component 1, 120, 130, 155 comprises a substrate 4 which, in particular in the case of components for use at high temperatures, e.g. in gas turbines 100 (FIG. 2), comprises a nickel- or cobalt-based superalloy according to FIG. 5.

The substrate 4 is preferably denser than the applied layers 7, 10, 13, 16.

A first, inner metallic layer 7 is applied to the substrate 4 and serves as a bond coat (BC) to a first, inner ceramic layer (TBC) 13. A second, outer metallic intermediate layer 10 is present on the first ceramic layer 13, and a further ceramic layer 16 is present as the outermost layer.

The compositions of the metallic layers 7 and 10 are preferably different, but are preferably based on MCrAl, in particular NiCoCrAl, very preferably with yttrium, the composition being selected such that it is appropriately matched to the respective temperature to which the metallic layers 7, 10 are exposed.

The outer metallic layer 10 has an appropriate ductility at the relatively high temperatures. The outer metallic layer 10 is preferably at a relatively high DTB temperature. DTB is the ductile-to-brittle transition point.

A further measure for assessing ductility is the strain-to-crack measurement. In order to ensure that the ductility is sufficient, in the strain-to-crack measurement it is preferable for the metallic layer 10 to have a value of at least 2%.

In the metallic layer 7, emphasis is placed on the protection of the base material against oxidation. Therefore, here the MCrAlY should be used with rhenium (Re).

Advantageous composition of the metallic layer 10:

Co, 30 Ni, 28 Cr, 8 Al, 0.6 Y and 0.7 Si.

Advantageous composition of the metallic layer 7:

Ni, 25 Co, 17 Cr, 10 Al, 0.3 Y and 1.5 Re.

The layer thickness of a metallic bond coat (BC) may be 200 μm to 300 μm.

The layer thicknesses of the ceramic layers (TBC) 13, 16 are preferably below a critical thickness, at which they would flake off as a singular layer.

The layer thickness of the ceramic layers is preferably up to 600 μm, in particular up to 500 μm, with a minimum thickness of 200 μm.

The overall layer thickness of 2×250 μm BCs plus 2×500 μm TBCs may be increased to 1000 μm, where the critical thickness of the individual layers is not reached in terms of microstructure/density.

In particular, the TBC having a total thickness of 1000 μm contributes to significantly increased thermal insulation. If the chemical composition is appropriate, the intermediate layer has a sufficient ductility, as a result of which failure of the overall coating system is prevented. The respective thickness of the TBC is below a critical thickness of 500 μm.

The gas inlet temperature into the gas turbine 100 can be increased, as a result of which the efficiency of the turbine can likewise be increased. By varying the properties of the first ceramic layer 13 and of the second ceramic layer 16 (e.g. composition, grain size, porosity), it is possible to optimize the coating system in terms of producibility, durability and thermally insulating action. In the event that the outer TBC 16 flakes off, the inner system 7, 13 which remains ensures sufficient emergency running properties.

FIG. 2 shows, by way of example, a partial longitudinal section through a gas turbine 100.

In the interior, the gas turbine 100 has a rotor 103 with a shaft which is mounted such that it can rotate about an axis of rotation 102 and is also referred to as the turbine rotor.

An intake housing 104, a compressor 105, a, for example, toroidal combustion chamber 110, in particular an annular combustion chamber, with a plurality of coaxially arranged burners 107, a turbine 108 and the exhaust-gas housing 109 follow one another along the rotor 103.

The annular combustion chamber 110 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133.

A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses.

To be able to withstand the temperatures which prevail there, they may be cooled by means of a coolant.

Substrates of the components may likewise have a directional structure, i.e. they are in single-crystal form (SX structure) or have only longitudinally oriented grains (DS structure).

By way of example, iron-based, nickel-based or cobalt-based superalloys are used as material for the components, in particular for the turbine blade or vane 120, 130 and components of the combustion chamber 110.

Superalloys of this type are known, for example, from EP 1 204 776 B1, EP 1 306 454, EP 1 319 729 A1, WO 99/67435 or WO 00/44949.

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

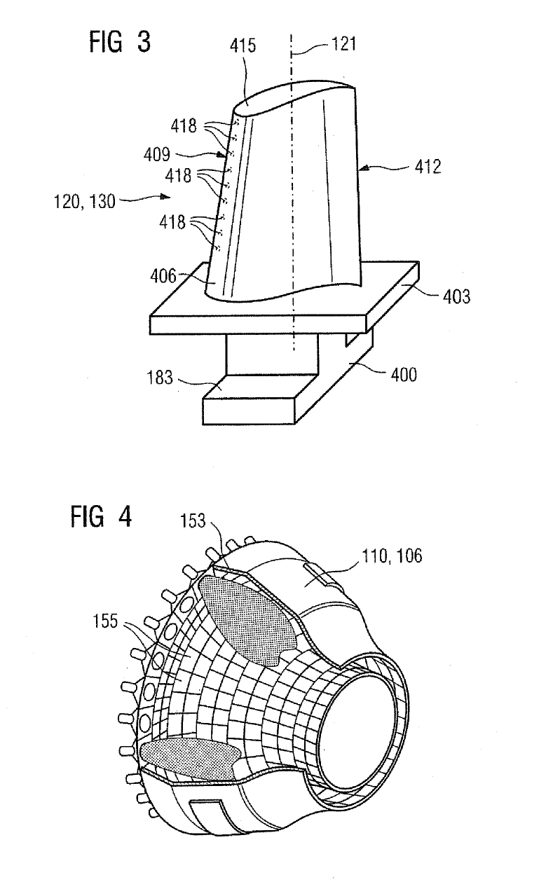

FIG. 3 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to faun the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1.

The density is preferably 95% of the theoretical density.

A protective aluminum oxide layer (TGO=thermally grown oxide layer) is formed on the MCrAlX layer (as an intermediate layer or as the outermost layer).

The layer preferably has a composition Co-30Ni-28Cr-8Al-0.6Y-0.7Si or Co-28Ni-24Cr-10Al-0.6Y. In addition to these cobalt-based protective coatings, it is also preferable to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is preferably the outermost layer and consists for example of ZrO₂, Y₂O₃-ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer. Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

The blade or vane 120, 130 may be hollow or solid in form. If the blade or vane 120, 130 is to be cooled, it is hollow and may also have film-cooling holes 418 (indicated by dashed lines).

FIG. 4 shows a combustion chamber 110 of the gas turbine 100. The combustion chamber 110 is configured, for example, as what is known as an annular combustion chamber, in which a multiplicity of burners 107, which generate flames 156, arranged circumferentially around an axis of rotation 102 open out into a common combustion chamber space 154. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

Moreover, a cooling system may be provided for the heat shield elements 155 and/or their holding elements, on account of the high temperatures in the interior of the combustion chamber 110. The heat shield elements 155 are then, for example, hollow and may also have cooling holes (not shown) opening out into the combustion chamber space 154.

On the working medium side, each heat shield element 155 made from an alloy is equipped with a particularly heat-resistant protective layer (MCrAlX layer and/or ceramic coating) or is made from material that is able to withstand high temperatures (solid ceramic bricks).

These protective layers may be similar to the turbine blades or vanes, i.e. for example MCrAlX: M is at least one element selected from the group consisting of iron (Fe), cobalt (Co), nickel (Ni), X is an active element and stands for yttrium (Y) and/or silicon and/or at least one rare earth element or hafnium (Hf). Alloys of this type are known from EP 0 486 489 B1, EP 0 786 017 B1, EP 0 412 397 B1 or EP 1 306 454 A1.

It is also possible for a, for example, ceramic thermal barrier coating to be present on the MCrAlX, consisting for example of ZrO₂, Y₂O₃-ZrO₂, i.e. unstabilized, partially stabilized or fully stabilized by yttrium oxide and/or calcium oxide and/or magnesium oxide.

Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thermal shocks.

Refurbishment means that after they have been used, protective layers may have to be removed from turbine blades or vanes 120, 130 or heat shield elements 155 (e.g. by sand-blasting). Then, the corrosion and/or oxidation layers and products are removed. If appropriate, cracks in the turbine blade or vane 120, 130 or in the heat shield element 155 are also repaired. This is followed by recoating of the turbine blades or vanes 120, 130 or heat shield elements 155, after which the turbine blades or vanes 120, 130 or the heat shield elements 155 can be reused.

1.-19. (canceled)

20. A multilayer coating system on a substrate, comprising:
a substrate;
a first metallic layer on the substrate;
a first ceramic layer on the first metallic layer;
a second metallic layer on the first ceramic layer; and
an outermost ceramic layer on the second metallic layer.

21. The multilayer coating system as claimed in claim 20, wherein the first metallic layer and the second metallic layer include a MCrAl-based composition.

22. The multilayer coating system as claimed in claim 20, wherein the first ceramic layer and the outermost ceramic layer include a zirconium oxide-based composition.

23. The multilayer coating system as claimed in claim 20, wherein a first layer thickness of the first metallic layer and of the second metallic layer is in a first range of 200 μm to 300 μm.

24. The multilayer coating system as claimed in claim 23, wherein the first layer thickness of the first metallic layer and of the second metallic layer are of equal thickness.

25. The multilayer coating system as claimed in claim 20, wherein a second layer thickness of the first ceramic layer and of the outermost ceramic layer is in a second range of 400 μm to 600 μm.

26. The multilayer coating system as claimed in claim 20, wherein the second metallic layer is more ductile than the first metallic layer.

27. The multilayer coating system as claimed in claim 20, wherein a chemical composition of the first ceramic layer and of the outermost ceramic layer are identical.

28. The multilayer coating system as claimed in claim 20, wherein a chemical composition of the first ceramic layer and the outermost ceramic layer are different.

29. The multilayer coating system as claimed in claim 20, wherein the compositions of the first metallic layer and of the second metallic layer differ significantly.

30. The multilayer coating system as claimed in claim 20, wherein the second metallic layer is a cobalt-based layer.

31. The multilayer coating system as claimed in claim 20, wherein the first metallic layer is a nickel-based layer.

32. The multilayer coating system as claimed in claim 20, wherein the second metallic layer comprises (in % by weight):
Co, 30% Ni, 28% Cr, 8% Al, 0.6% Y and 0.7% Si.

33. The multilayer coating system as claimed in claim 20, wherein the first metallic layer comprises (in % by weight):
Ni, 25% Co, 17% Cr, 10% Al, 0.3% Y and 1.5% Re.

34. The multilayer coating system as claimed in claim 20, wherein the first metallic layer includes a higher aluminum content than the second metallic layer.

35. The multilayer coating system as claimed in claim 20, wherein the first metallic layer comprises rhenium and the second metallic layer does not comprise rhenium.

36. The multilayer coating system as claimed in claim 20, wherein the multilayer coating system consists of a substrate, two metallic layers and two ceramic layers.

37. The multilayer coating system as claimed in claim 20, wherein at least the outermost ceramic layer includes a pyrochlore structure.

38. The multilayer coating system as claimed in claim 20, wherein the first ceramic layer includes a zirconium oxide-based composition.

39. The multilayer coating system as claimed in claim 20, wherein the outermost ceramic layer comprises zirconium oxide.
